(19) United States
(12) Patent Application Publication
(10) Pub. No.: US 2009/0168600 A1
(43) Pub. Date: Jul. 2, 2009

(54) SEPARATING SEISMIC SIGNALS PRODUCED BY INTERFERING SEISMIC SOURCES

(76) Inventors: IAN MOORE, Highfields Caldecote (GB); DAVID E. NICHOLS, Houston, TX (US); CLEMENT KOSTOV, Great Wilbraham (GB)

Correspondence Address: WesternGeco L.L.C.;Jeffrey E. Griffin, 10001 Richmond Avenue, HOUSTON, TX, 77042-4299, US

(21) Appl. No.: 11/964,402

(22) Filed: Dec. 26, 2007

(51) Int. Cl. G01V 1/28

(52) U.S. Cl. 367/38

(57) ABSTRACT

A technique includes obtaining seismic data indicative of measurements acquired by seismic sensors of a composite seismic signal produced by the firings of multiple seismic sources. The technique includes associating models that describe geology associated with the composite seismic signal with linear operators and characterizing the seismic data as a function of the models and the associated linear operators. The technique includes simultaneously determining the models based on the function and based on the determined models, generating datasets. Each dataset is indicative of a component of the composite seismic signal and is attributable to a different one of the seismic sources.

### BACKGROUND

The invention generally relates to separating seismic signals produced by interfering seismic sources.

Seismic exploration involves surveying subterranean geological formations for hydrocarbon deposits. A survey typically involves deploying seismic source(s) and seismic sensors at predetermined locations. The sources generate seismic waves, which propagate into the geological formations creating pressure changes and vibrations along their way. Changes in elastic properties of the geological formation scatter the seismic waves, changing their direction of propagation and other properties. Part of the energy emitted by the sources reaches the seismic sensors. Some seismic sensors are sensitive to pressure changes (hydrophones), others to particle motion (e.g., geophones), and industrial surveys may deploy only one type of sensors or both. In response to the detected seismic events, the sensors generate electrical signals to produce seismic data. Analysis of the seismic data can then indicate the presence or absence of probable locations of hydrocarbon deposits.

Some surveys are known as “marine” surveys because they are conducted in marine environments. However, “marine” surveys may be conducted not only in saltwater environments, but also in fresh and brackish waters. In one type of marine survey, called a “towed-array” survey, an array of seismic sensor-containing streamers and sources is towed behind a survey vessel.

### SUMMARY

In an embodiment of the invention, a technique includes obtaining seismic data indicative of measurements acquired by seismic sensors of a composite seismic signal produced by the firings of multiple seismic sources. The technique includes associating models that describe geology associated with the composite seismic signal with linear operators and characterizing the seismic data as a function of the models and the associated linear operators. The technique includes simultaneously determining the models based on the function and based on the determined models, generating datasets. Each dataset is indicative of a component of the composite seismic signal and is attributable to a different one of the seismic sources.

In another embodiment of the invention, a system includes an interface and a processor. The interface receives seismic data indicative of measurements acquired by seismic sensors of a composite seismic signal produced by the firings of multiple seismic sources. The processor processes the seismic data to associate linear operators with models that describe geology associated with the composite seismic signal; characterize the seismic data as a function of the models and the associated linear operators; simultaneously determine the models based on the function; and based on the determined models, generate datasets. Each dataset is indicative of a component of the composite seismic signal and is attributable to a different one of the seismic sources.

In yet another embodiment of the invention, an article includes a computer accessible storage medium containing instructions that when executed by a processor-based system cause the processor-based system to receive seismic data indicative of measurements acquired by seismic sensors of a composite seismic signal produced by the firings of multiple seismic sources. The instructions when executed cause the processor-based system to process the seismic data to associate linear operators with models that describe geology associated with the composite seismic signal; characterize the seismic data as a function of the models and the associated linear operators; simultaneously determine the models based on the function; and based on the determined models, generate datasets. Each dataset is indicative of a component of the composite seismic signal and is attributable to a different one of the seismic sources.

Advantages and other features of the invention will become apparent from the following drawing, description and claims.

### BRIEF DESCRIPTION OF THE DRAWING

FIG. 1 is a schematic diagram of a marine-based seismic acquisition system according to an embodiment of the invention.

FIGS. 2, 3 and 11 are flow diagrams depicting techniques to separate seismic signals produced by interfering seismic sources according to embodiments of the invention.

FIGS. 4, 5, 6, 7, 8, 9 and 10 are simulated source and receiver signals illustrating separation of a composite seismic signal into signals identifiable with the originating sources according to an embodiment of the invention.

FIG. 12 is a schematic diagram of a data processing system according to an embodiment of the invention.

### DETAILED DESCRIPTION

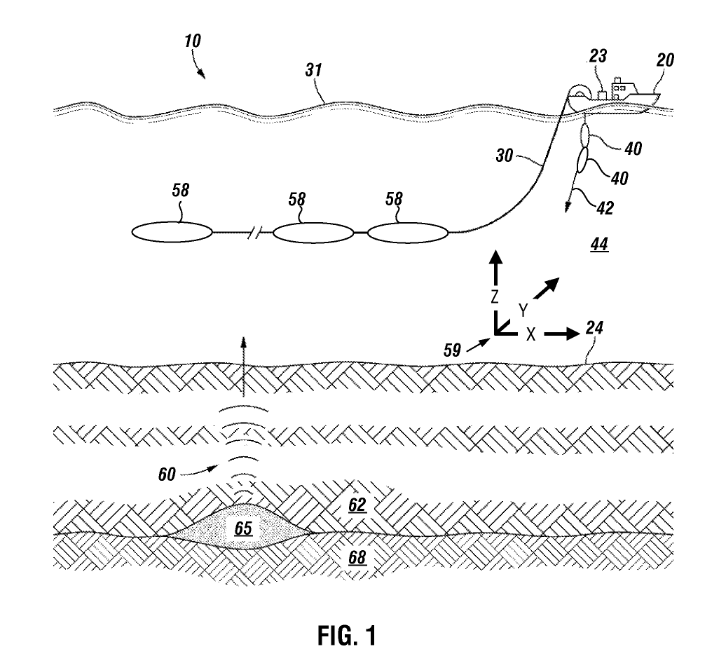

FIG. 1 depicts an embodiment 10 of a marine-based seismic data acquisition system in accordance with some embodiments of the invention. In the system 10, a survey vessel 20 tows one or more seismic streamers 30 (one exemplary streamer 30 being depicted in FIG. 1) behind the vessel 20. It is noted that the streamers 30 may be arranged in a spread in which multiple streamers 30 are towed in approximately the same plane at the same depth. As another non-limiting example, the streamers may be towed at multiple depths, such as in an over/under spread, for example.

The seismic streamers 30 may be several thousand meters long and may contain various support cables (not shown), as well as wiring and/or circuitry (not shown) that may be used to support communication along the streamers 30. In general, each streamer 30 includes a primary cable into which is mounted seismic sensors that record seismic signals. The streamers 30 contain seismic sensors 58, which may be, depending on the particular embodiment of the invention, hydrophones (as one non-limiting example) to acquire pressure data or multi-component sensors. For embodiments of the invention in which the sensors 58 are multi-component sensors (as another non-limiting example), each sensor is capable of detecting a pressure wavefield and at least one component of a particle motion that is associated with acoustic signals that are proximate to the sensor. Examples of particle motions include one or more components of a particle displacement, one or more components (inline (x), crossline (y) and vertical (z) components (see axes 59, for example)) of a particle velocity and one or more components of a particle acceleration.

Depending on the particular embodiment of the invention, the multi-component seismic sensor may include one or more hydrophones, geophones, particle displacement sensors, particle velocity sensors, accelerometers, pressure gradient sensors, or combinations thereof.

For example, in accordance with some embodiments of the invention, a particular multi-component seismic sensor may include a hydrophone for measuring pressure and three orthogonally-aligned accelerometers to measure three corresponding orthogonal components of particle velocity and/or acceleration near the sensor. It is noted that the multi-component seismic sensor may be implemented as a single device (as depicted in FIG. 1) or may be implemented as a plurality of devices, depending on the particular embodiment of the invention. A particular multi-component seismic sensor may also include pressure gradient sensors, which constitute another type of particle motion sensors. Each pressure gradient sensor measures the change in the pressure wavefield at a particular point with respect to a particular direction. For example, one of the pressure gradient sensors may acquire seismic data indicative of, at a particular point, the partial derivative of the pressure wavefield with respect to the crossline direction, and another one of the pressure gradient sensors may acquire, a particular point, seismic data indicative of the pressure data with respect to the inline direction.

The marine seismic data acquisition system 10 includes one or more seismic sources 40 (two exemplary seismic sources 40 being depicted in FIG. 1), such as air guns and the like. In some embodiments of the invention, the seismic sources 40 may be coupled to, or towed by, the survey vessel 20. Alternatively, in other embodiments of the invention, the seismic sources 40 may operate independently of the survey vessel 20, in that the sources 40 may be coupled to other vessels or buoys, as just a few examples.

As the seismic streamers 30 are towed behind the survey vessel 20, acoustic signals 42 (an exemplary acoustic signal 42 being depicted in FIG. 1), often referred to as “shots,” are produced by the seismic sources 40 and are directed down through a water column 44 into strata 62 and 68 beneath a water bottom surface 24. The acoustic signals 42 are reflected from the various subterranean geological formations, such as an exemplary formation 65 that is depicted in FIG. 1.

The incident acoustic signals 42 that are acquired by the sources 40 produce corresponding reflected acoustic signals, or pressure waves 60, which are sensed by the seismic sensors 58. It is noted that the pressure waves that are received and sensed by the seismic sensors 58 include “up going” pressure waves that propagate to the sensors 58 without reflection, as well as “down going” pressure waves that are produced by reflections of the pressure waves 60 from an air-water boundary 31.

The seismic sensors 58 generate signals (digital signals, for example), called “traces,” which indicate the acquired measurements of the pressure wavefield and particle motion. The traces are recorded and may be at least partially processed by a signal processing unit 23 that is deployed on the survey vessel 20, in accordance with some embodiments of the invention. For example, a particular seismic sensor 58 may provide a trace, which corresponds to a measure of a pressure wavefield by its hydrophone 55; and the sensor 58 may provide (depending on the particular embodiment of the invention) one or more traces that correspond to one or more components of particle motion.

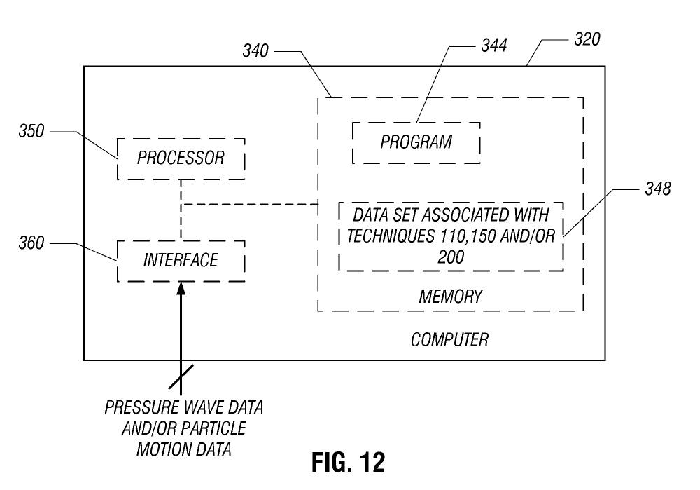

The goal of the seismic acquisition is to build up an image of a survey area for purposes of identifying subterranean geological formations, such as the exemplary geological formation 65. Subsequent analysis of the representation may reveal probable locations of hydrocarbon deposits in subterranean geological formations. Depending on the particular embodiment of the invention, portions of the analysis of the representation may be performed on the seismic survey vessel 20, such as by the signal processing unit 23. In accordance with other embodiments of the invention, the representation may be processed by a seismic data processing system (such as an exemplary seismic data processing system 320 that is depicted in FIG. 12 and is further described below) that may be, for example, located on land or on the vessel 20. Thus, many variations are possible and are within the scope of the appended claims.

A particular seismic source 40 may be formed from an array of seismic source elements (such as air guns, for example) that may be arranged in strings (gun strings, for example) of the array. Alternatively, a particular seismic source 40 may be formed from one or a predetermined number of air guns of an array, may be formed from multiple arrays, etc. Regardless of the particular composition of the seismic sources, the sources may be fired in a particular time sequence during the survey.

As described in more detail below, the seismic sources 40 may be fired in a sequence such that multiple seismic sources 40 may be fired simultaneously or near simultaneously in a short interval of time so that a composite energy signal that is sensed by the seismic sensors 58 contain a significant amount of energy from more than one seismic source 40. In other words, the seismic sources interfere with each other such that the composite energy signal is not easily separable into signals that are attributed to the specific sources. The data this is acquired by the seismic sensors 58 is separated, as described below, into datasets that are each associated with one of the seismic sources 40 so that each dataset indicates the component of the composite seismic energy signal that is attributable to the associated seismic source 40.

In a conventional towed marine survey, a delay is introduced between the firing of one seismic source and the firing of the next seismic source, and the delay is sufficient to permit the energy that is created by the firing of one seismic source to decay to an acceptable level before the energy that is associated with the next seismic source firing arrives. The use of such delays, however, imposes constraints on the rate at which the seismic data may be acquired. For a towed marine survey, these delays also imply a minimum inline shot interval because the minimum speed of the survey vessel is limited.

Thus, the use of simultaneously-fired or near-simultaneously-fired seismic sources in which signals from the sources interfere for at least part of each record, has benefits in terms of acquisition efficiency and inline source sampling. For this technique to be useful, however, the acquired seismic data must be separated into the datasets that are each uniquely associated with one of the seismic sources.

One conventional technique for enabling the separation for interfering seismic sources makes use of relatively small delays (random delays, for example) between the firings of seismic sources (i.e., involves the use of source dithering). The resulting seismic traces are collected into a domain that includes many firings of each source. The traces are aligned such that time zero corresponds to the firing time for a specific source so that the signal acquired due to the specific seismic source appears coherent while the signal acquired due to the other seismic sources appear incoherent. The acquired signals are separated based on coherency.

It has been observed that the apparently incoherent signal may not be mathematically incoherent, because the time delays between seismic source firings that make the signal appear to be incoherent are known. Therefore, in accordance with embodiments of the invention described herein, all of the energy that is acquired due to interfering seismic source firings is treated as a single composite energy signal; and linear operator transforms are used for purposes of decomposing the composite energy signal into signals that are each uniquely associated with a particular seismic source.

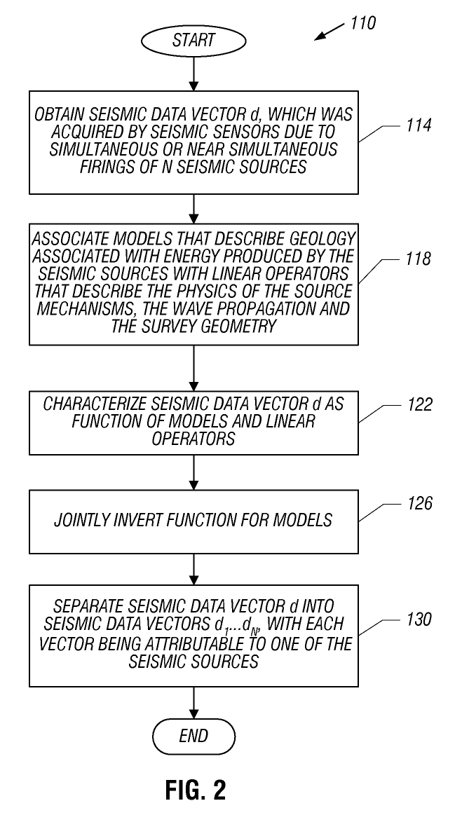

More specifically, FIG. 2 depicts a technique 110 that may be generally used for purposes of separating seismic sensor data that was acquired due to the firings of interfering seismic sources. Referring to FIG. 2, the technique 110 includes obtaining seismic data (referred to as a “seismic data vector d”), which was acquired by the seismic sensors due to the firings of N (i.e., multiple) seismic sources. Thus, the seismic sources were fired simultaneously or in a near simultaneous manner such that significant energy from all of these firings are present in the seismic data vector d. Pursuant to block 118, models, which describe the geology that affects the source energy are associated with linear operators, which describe the physics of the source mechanisms, the wave propagation and the survey geometry. The seismic data vector d is characterized (block 122) as a function of the models and the linear operators. This function is then jointly inverted for the models, which permits the seismic data vector d to be separated (block 130) into N seismic datasets d₁ . . . d_{N} such that each dataset is uniquely attributable to one of the seismic sources. In other words each dataset represents a component of the sensed composite energy signal, which is uniquely attributable to one of the seismic sources.

As a more specific example, assume that the seismic data vector d is acquired due to the near simultaneous firing of two seismic sources called “S₁” and “S₂” For this example, the seismic sources S₁ and S₂ are fired pursuant to a timing sequence, which may be based on a predetermined timing pattern or may be based on random or pseudo-random times. Regardless of the particular timing scheme, it is assumed for this example that the seismic source S₁ is fired before the seismic source S₂ for all traces, and it is further assumed that the zero times of the traces correspond to the firing times for S₁. Thus, the zero times of the traces are in “S₁ time.” The offsets, or vectors, to the seismic sources S₁ and S₂ are called “x¹” and “x²,” respectively. The timing delays, denoted by “t” for the seismic source S₂ are known for each trace.

It is assumed for this example that the collection of traces are such that the values of t are random. In practice, this is the case for a CMP, receiver or common offset gather. For purposes of simplifying this discussion, it is assumed that the trace in each gather may be located with respect to the seismic source S₁ and seismic source S₂ using scalar quantities called “x¹ᵢ” and “x²ᵢ,” respectively. In this notation, the subscript “i” denotes the trace number in the gather. As a more specific example, for a CMP gather, “x¹ᵢ” may be the scalar offset to the seismic source S₁, and these quantities are referred to as offsets below. Similarly, “tᵢ” denotes the timing delay for the i^{th} trace.

The recorded energy for the seismic source S₁ may be modeled by applying a linear operator called “L₁” (which represents the physics of the seismic source S₁, the wave propagation associated with the source S₁ and the survey geometry associated with the seismic source S₁) to an unknown model called “m₁,” which describes the geology that affects the energy that propagates from the seismic source S₁. The model m₁ contains one element for each parameter in the model space. Typically the model space may be parameterized by slowness or its square, corresponding to linear or hyperbolic/parabolic Radon transforms, respectively. The linear operator L₁ is a function of the offsets to the source S₁, the parameters that characterize the model space, and time or frequency. A seismic data vector d₁ contains one element for each trace (at each time or frequency) and is the component of the seismic data d, which is associated with the seismic source S₁. In other words, the seismic data vector d₁ represents the dataset attributable to the seismic source S₁. The seismic data vector d₁ may be described as follows:

d₁=L₁m₁. Eq. 1

The energy that is associated with the seismic source S₂ appears incoherent in the seismic data vector d. However, the energy is related to a coherent dataset in which the firing times for the seismic source S₂ are at time zero (i.e., seismic source S₂ time) by the application of time shifts tᵢ to the traces. A diagonal linear operator called “D₂” may be used for purposes of describing these time shifts, such that the component of the seismic data vector d, which is associated with the seismic source S₂ and which is called “d₂” may be described as follows:

d₂=D₂L₂m₂. Eq. 2

In Eq. 2, a linear operator called “L₂” represents the physics of the seismic source S₂, the wave propagation associated with the seismic source S₂ and the survey geometry associated with the seismic source S₂. Also in Eq. 2, a model called “m₂” describes the geology that affects the energy that propagates from the seismic source S₂.

The composite seismic energy signal that is recorded by the seismic sensors is attributable to both seismic sources S₁ and S₂. Thus, the seismic data vector d (i.e., the recorded data) is a combination of the seismic data vectors d₁ and d₂, as described below:

d=d₁+d₂. Eq. 3

Due to the relationships in Eqs. 1, 2 and 3, the seismic data vector d may be represented as the following linear system:

$$d = [ \begin{matrix}{L}_{1} & {D}_{2} {L}_{2}\end{matrix} ] [ \begin{matrix}{m}_{1} \\ {m}_{2}\end{matrix} ] . \qquad Eq . 4$$

Thus, Eq. 4 may be solved (i.e., jointly inverted) for the model vector m (i.e., (m₁; m₂)) using standard techniques, such as the least squares algorithm; and after the model vector m is known, Eqs. 1 and 2 may be applied with the models m₁ and m₂ for purposes of separating the seismic data vector d into the seismic data vectors d₁ and d₂, i.e., into the datasets that indicate the measurements attributable to each seismic source.

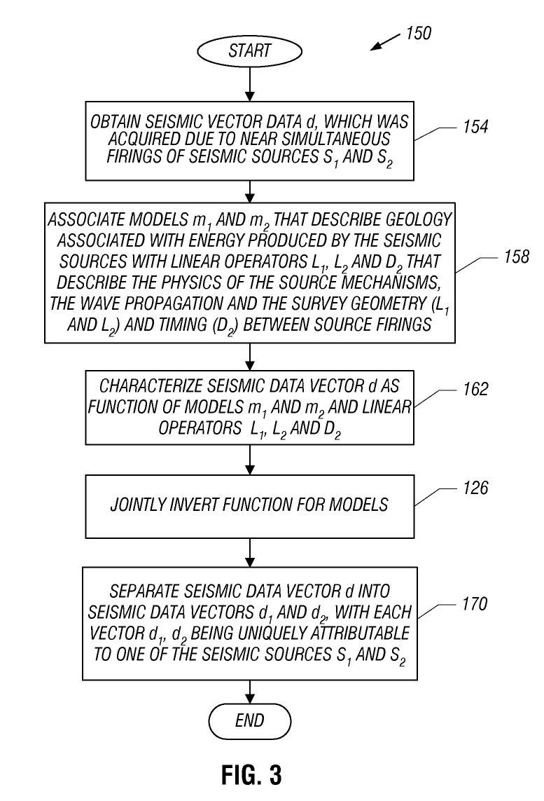

Thus, referring to FIG. 3, in accordance with some embodiments of the invention, a technique 150 may be used for separating seismic data that is produced by interfering seismic sources (two seismic sources for this example). Pursuant to the technique 150, seismic data vector d is obtained, which was acquired due to the near simultaneous firings of seismic sources, pursuant to block 154. Pursuant to block 158, models m₁ and m₂ are associated with linear operators L₁, L₂ and D₂ that describe the physics of the source mechanisms, the wave preparation and survey geometry (L₁ and L₂) and the timing (D₂) between the source firings. The seismic data vector d is then characterized (block 162) as a function of the models m₁ and m₂ and the linear operators L₁, L₂ and D₂. The function is then jointly inverted, pursuant to block 166, for the models m₁ and m₂; and then, the seismic data vector d may be separated into the seismic data vectors d₁ and d₂, pursuant to block 170.

Eq. 4 may be inverted in the frequency (ω) domain. In that case, (D₂)ⱼₖ=exp(−iωtⱼ)δⱼₖ and (Lₛ)ⱼₖ=exp(−iωt^{s}ⱼₖ), where t^{s}ⱼₖ is the time shift associated with offset x^{s}ⱼ and the parameter for the k^{th} trace in the model space associated with Sₛ. For a linear Radon transform parameterized by slowness, p^{s}ₖ, t^{s}ⱼₖ=x^{s}ⱼp^{s}ₖ. For a parabolic Radon transform parameterized by curvature, q^{s}ₖ, t^{s}ⱼₖ=(x^{s}j)² q^{s}ₖ.

The success of the source separation technique described above depends on the ability of the transform to separate the energy associated with the two sources. Unlike most applications of Radon transforms, success does not depend on the ability to focus energy at the correct model parameter within m₁ or m₂. When random or pseudo time delays are used between source firings, the basis functions for the two model domains (t¹ⱼₖ and tⱼ+t²ⱼₖ) are very different, and this enables extremely effective separation of the sources.

Details of the parameterization of the model domain are not important, provided it is possible to model the recorded data using that domain. For example, for a linear Radon transform, the slowness range must cover the range observed in the data, and the sampling must be adequate to avoid aliasing. The use of high-resolution transforms to improve focusing is not expected to be necessary in general. However, high-resolution transforms can be used if required, for instance because of poor sampling in offset created by offset windowing or acquisition geometry issues.

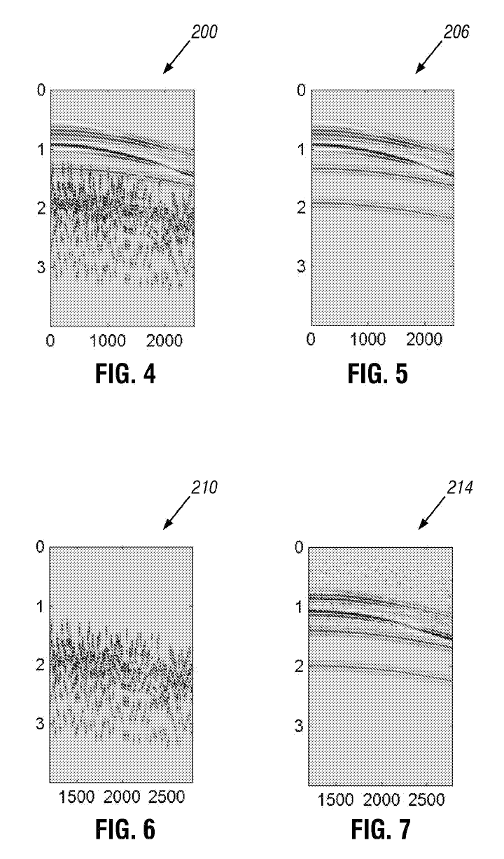

FIGS. 5, 6, 7, 8, 9 and 10 depict examples of the technique 150 when applied to a simple, synthetic dataset. Input signals 200 (see FIG. 4) to the separation process (i.e., the simulated signals recorded by the seismic sensors) are formed by adding synthetic signals 206 (see FIG. 5) and 210, which corresponding to the seismic sources S₁ and S₂, respectively. The input signals 200 also contain random noise, and the signals 200 are in S₁ time. The signals 206 contain 10 hyperbolic events with random zero-offset times, amplitudes and velocities and a 30 Hz Ricker wavelet. The input signals 200 correspond to input signals 214 in FIG. 7 for S₂ time. As can be seen from FIG. 7, the removal of the time delays makes the S₂-related signals 214 coherent.

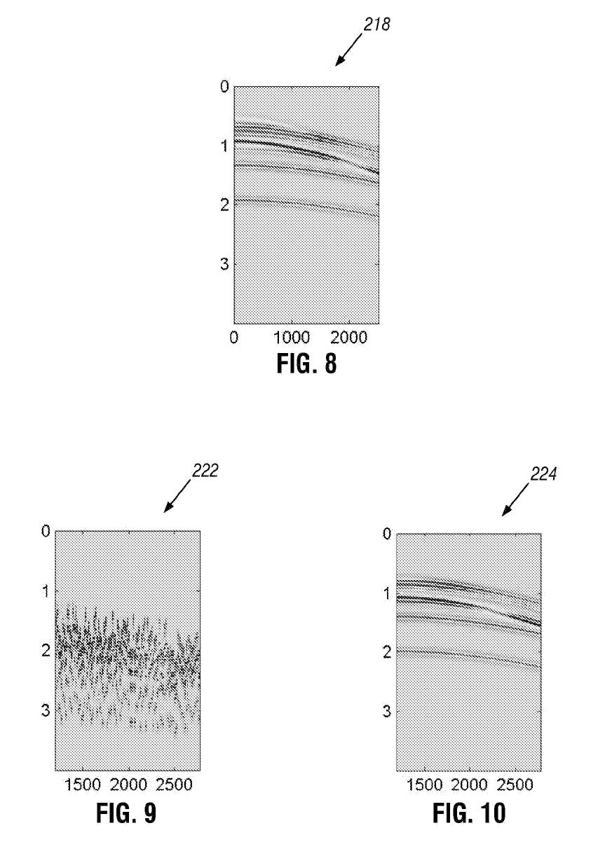

The separation process is directed at recovering the S₁ input signals 206 (FIG. 5) and S₂ input signals 210 (FIG. 5) from the acquired input signals 200 (FIG. 4). The resulting estimates are depicted in FIG. 8 (separated S₁ signals 218) and 9 (separated S₂ signals 222), respectively. Nearly all of the energy in the input signals 200 appears in either the signals 218 or the signals 222. The S₂-related data may be made coherent by time-shifting to S₂-time, as shown by signals 224 of FIG. 10. The output data (i.e., signals 218 and 224) may then be processed in a conventional seismic data processing flow, using offsets to S₁ and S₂, respectively.

Although the examples that are described above use source dithering, or non-simultaneous firing of the seismic sources, the seismic sources may be fired simultaneously, in accordance with other embodiments of the invention. In this regard, if the linear operators are made more unique predictors of the seismic data, then the requirement for the dithering of the source firings becomes less important. In other words, source dithering may be less important if there is less overlap of the basis functions for the seismic source locations.

As a more specific example, the techniques that are described herein may be combined with other techniques for source separation for purposes of causing the linear operators to be more unique predictors of the seismic data. For example, some parts of the wavefields (such as the direct arrivals, for example) may be estimated deterministically and subtracted as a pre-processing step. In addition, methods such as dip-filtering may be used in combination with the techniques that are described herein.

As a more specific example, the energy that is recorded from the seismic source S₁ may be viewed as a combination of energy produced by direct arrivals and energy that is produced by reflections. As such, the seismic data vector d₁ may be effectively represented as follows:

d₁=d₁ₗ+d₁ₕ=L₁mₗ+H₁mₕ, Eq. 5

where “d₁ₗ” represents the seismic data attributable to direct arrivals from the seismic source S₁; “d₁ₕ” represents the seismic data attributable to reflections produced due to the seismic source S₁; “L₁” represents a linear Radon operator associated with the direct arrivals from the seismic source S₁; “mₗ” represents a model describing the geology that affects the direct arrivals; “H₁” represents a hyperbolic Radon transform operator associated with the reflections produced due to energy from the seismic source S₁; and “mₕ” represents a model that describes the geology that affects the reflections produced by the seismic sources.

Similarly, the seismic data vector, which is d₂ attributable to energy that is recorded from the seismic source S₂, may be described as follows:

d₂=d₂ₗ+d₂ₕ=L₂mₗ+H₂mₕ, Eq. 6

where “d₂ₗ” represents the component of the seismic data vector d₂ attributable to direct arrivals; “d₂ₕ” represents the seismic data d₂ attributable to reflections; “L₂” represents a linear Radon transform operator associated with the direct arrivals from the seismic source S₂; and “H₂” represents the hyperbolic Radon transform associated with the reflections produced due to the energy from the seismic source S₂.

Due to the relationships that are set forth in Eqs. 5 and 6, the seismic data vector d, which represents the actual data recorded by the seismic sensors, may be represented as follows:

d=d₁ₗ+d₁ₕ+d₂ₗ+d₂ₕ, Eq. 7

Thus, the seismic data vector d may be represented by the following function, which may be inverted for the models m₁ and mₕ:

$$d = [ \begin{matrix}( {L}_{1} + {L}_{2} ) & ( {H}_{1} + {H}_{2} )\end{matrix} ] [ \begin{matrix}{m}_{l} \\ {m}_{h}\end{matrix} ] . \qquad Eq . 8$$

Eqs. 5 and 6 may then be applied to derive the data vectors d₁ and d₂.

Although linear and hyperbolic Radon transforms have been described above, it is noted that other linear operators may be used, in accordance with other embodiments of the invention. For example, parabolic or migration operators may be used in accordance with other embodiments of the invention, as just a few other non-limiting examples.

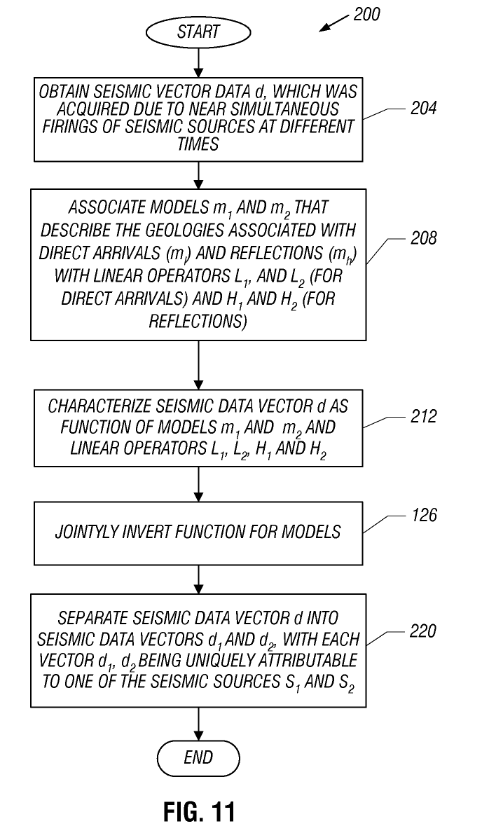

Thus, referring to FIG. 11, a technique 200 may be used in accordance with some embodiments of the invention for purposes of separating seismic data acquired due to energy that is produced by interfering seismic sources, which are two seismic sources S₁ and S₂ for this example. Pursuant to the technique 200, a seismic data vector d is obtained (block 204), which was acquired due to the firings of the seismic sources. Models that describe geologies associated with the direct arrivals (mₗ) and the reflections (mₕ) are associated (block 208) with linear operators L₁ and L₂ (for direct arrivals) and H₁ and H₂ (for reflections). Pursuant to block 212, the seismic data vector d is characterized as a function of models mₗ and mₕ and linear operators, L₁, L₂, H₁ and H₂. The function is then jointly inverted, pursuant to block 216, for the models m₁ and mₕ. Subsequently, the seismic data vector d may be separated, pursuant to block 220, into the data subset vectors d₁ and d₂.

Although the example that is set forth herein is for two seismic sources S₁ and S₂, the techniques may be extended to more than two sources.

Referring to FIG. 12, in accordance with some embodiments of the invention, a seismic data processing system 320 may perform at least some of the techniques that are disclosed herein for purposes of separating seismic data acquired are due to energy that is produced by interfering seismic sources. In accordance with some embodiments of the invention, the system 320 may include a processor 350, such as one or more microprocessors and/or microcontrollers. The processor 350 may be located on a streamer 30 (FIG. 1), located on the vessel 20 or located at a land-based processing facility (as examples), depending on the particular embodiment of the invention.

The processor 350 may be coupled to a communication interface 360 for purposes of receiving seismic data that corresponds to pressure and/or particle motion measurements from the seismic sensors 58. Thus, in accordance with embodiments of the invention described herein, the processor 350, when executing instructions stored in a memory of the seismic data processing system 320, may receive multi-component data and/or pressure sensor data that are acquired by seismic sensors while in tow. It is noted that, depending on the particular embodiment of the invention, the data may be data that are directly received from the sensors as the data are being acquired (for the case in which the processor 350 is part of the survey system, such as part of the vessel or streamer) or may be sensor data that were previously acquired by seismic sensors while in tow and stored and communicated to the processor 350, which may be in a land-based facility, for example.

As examples, the interface 360 may be a USB serial bus interface, a network interface, a removable media (such as a flash card, CD-ROM, etc.) interface or a magnetic storage interface (IDE or SCSI interfaces, as examples). Thus, the interface 360 may take on numerous forms, depending on the particular embodiment of the invention.

In accordance with some embodiments of the invention, the interface 360 may be coupled to a memory 340 of the seismic data processing system 320 and may store, for example, various input and/or output datasets involved with processing the seismic data in connection with the techniques 110, 150 and/or 200, as indicated by reference numeral 348. The memory 340 may store program instructions 344, which when executed by the processor 350, may cause the processor 350 to perform various tasks of or more of the techniques that are disclosed herein, such as the techniques 110, 150 and/or 200 and display results obtained via the technique(s) on a display (not shown in FIG. 12) of the system 320, in accordance with some embodiments of the invention.

Other embodiments are within the scope of the appended claims. For example, in accordance with other embodiments of the invention, “amplitude dithering” may be used to aid separation. Although control of the amplitude of a towed seismic source may, in general, be challenging, in accordance with embodiments of the invention, the seismic sources may be controlled by deliberately not firing selected seismic sources according to some random or regular pattern. As another example, the amplitude dithering may includes selectively firing some source elements (such as guns, for example) of a particular source while not firing other elements of the source to vary the amplitude.

Information regarding the amplitude dithering may be incorporated into the above-described linear operators.

In practice, occasionally one of the seismic sources may fail to fire. When this occurs, the information regarding the failed seismic source may be included into the associated linear operator by forcing the operator to have zero output for the corresponding trace. These misfires, in turn, may make the different seismic sources easier to separate.

Other embodiments are within the scope of the appended claims. For example, although a towed marine-based seismic acquisition system has been described above, the techniques and systems described herein for separating seismic signals produced by interfering seismic sources may likewise be applied to other types of seismic acquisition systems. As non-limiting examples, the techniques and system that are described herein may be applied to seabed, borehole and land-based seismic acquisition systems. Thus, the seismic sensors and sources may be stationary or may be towed, depending on the particular embodiment of the invention. As other examples of other embodiments of the invention, the seismic sensors may be multi-component sensors that acquire measurements of particle motion and pressure, or alternatively the seismic sensors may be hydrophones only, which acquire pressure measurements. Thus, many variations are contemplated and are within the scope of the appended claims.

While the present invention has been described with respect to a limited number of embodiments, those skilled in the art, having the benefit of this disclosure, will appreciate numerous modifications and variations therefrom. It is intended that the appended claims cover all such modifications and variations as fall within the true spirit and scope of this present invention.

What is claimed is:

1. A method comprising:
obtaining seismic data indicative of measurements acquired by seismic sensors of a composite seismic signal produced by the firings of multiple seismic sources;
associating models with linear operators, the models describing geology associated with the composite seismic signal;
characterizing the seismic data as a function of the models and the associated linear operators;
simultaneously determining the models based on the function; and
based on the determined models, generating datasets, each dataset being indicative of a component of the composite seismic signal and being attributable to a different one of the seismic sources.

2. The method of claim 1, wherein the act of simultaneously determining comprises jointly inverting the function for the models.

3. The method of claim 1, wherein the seismic sources are fired simultaneously.

4. The method of claim 1, wherein
the seismic sources comprise a first seismic source and a second seismic source fired at different times than the first seismic source, and
the act of associating comprises associating the second seismic source with a linear operator that describes the firing time difference between the first and second seismic sources.

5. The method of claim 4, wherein a the second seismic source is fired at times relative to the first seismic source pursuant to a timing pattern of predetermined time intervals.

6. The method of claim 4, wherein the second seismic source is fired at times relative to the first seismic source pursuant to a timing pattern controlled by a random number generator.

7. The method of claim 1, wherein the act of associating comprises associating models describing geologies associated with direct arrivals and reflections produced by the firings of the seismic sources.

8. The method of claim 1, wherein the linear operators comprise linear Radon operators and hyperbolic Radon operators.

9. The method of claim 1, wherein the linear operators comprise at least one operator selected from the following: a linear Radon operator, a hyperbolic Radon operator, a parabolic operator and a migration operator.

10. The method of claim 1, wherein amplitudes of the seismic sources are varied with respect to each other in a controlled manner.

11. The method of claim 10, wherein the amplitudes of the seismic sources are varied according to a random or a pseudo random manner or pursuant to a predetermined pattern of amplitude variation.

12. A system comprising:
an interface to receive seismic data indicative of measurements acquired by seismic sensors of a composite seismic signal produced by the firings of multiple seismic sources; and
a processor to process the seismic data to associate linear operators with models that describe geology associated with the composite seismic signal, characterize the seismic data as a function of the models and the associated linear operators, simultaneously determine the models based on the function and based on the determined models, generate datasets;
wherein each dataset is indicative of a component of the composite seismic signal and being attributable to a different one of the seismic sources.

13. The system of claim 12, wherein the processor is adapted to process the seismic data to jointly inverting the function for the models.

14. The system of claim 12, wherein the seismic sources are fired simultaneously.

15. The system of claim 12, wherein
the seismic sources comprise a first seismic source and a second seismic source fired at different times than the first seismic source, and
the processor is adapted to associate the second seismic source with a linear operator that describes the firing time difference between the first and second seismic sources.

16. The system of claim 12, wherein the linear operators comprise at least one operator selected from the following: a linear Radon operator, a hyperbolic Radon operator, a parabolic operator and a migration operator.

17. The system of claim 12, further comprising:
at least one towed streamer containing the seismic sensors, wherein the processor is located on said at least one towed streamer.

18. The system of claim 17, further comprising:
a vessel to tow said at least one towed streamer.

19. The system of claim 10, wherein amplitudes of the seismic sources are varied with respect to each other in a controlled manner.

20. The system of claim 19, wherein the amplitudes of the seismic sources are varied according to a random or a pseudo random manner or pursuant to a predetermined pattern of amplitude variation.

21. An article comprising a computer accessible storage medium containing instructions that when executed by a processor-based system cause the processor-based system to:
receive seismic data indicative of measurements acquired by seismic sensors of a composite seismic signal produced by the firings of multiple seismic sources; and
process the seismic data to associate with linear operators with models that describe geology associated with the composite seismic signal, characterize the seismic data as a function of the models and the associated linear operators, simultaneously determine the models based on the function and based on the determined models, generate datasets;
wherein each dataset is indicative of a component of the composite seismic signal and being attributable to a different one of the seismic sources.

22. The article of claim 21, the storage medium containing instructions that when executed by the processor-based system cause the processor-based system to process the seismic data to jointly invert the function for the models.

23. The article of claim 21, wherein the seismic sources are fired simultaneously.

24. The article of claim 21, wherein
the seismic sources comprise a first seismic source and a second seismic source fired at different times than the first seismic source, and
the storage medium containing instructions that when executed by the processor-based system cause the processor-based system to associate the second seismic source with a linear operator that describes the firing time difference between the first and second seismic sources.

25. The article of claim 21, wherein the linear operators comprise at least one operator selected from the following: a linear Radon operator, a hyperbolic Radon operator, a parabolic operator and a migration operator.
